(19) United States
(12) Patent Application Publication
(10) Pub. No.: US 2021/0326392 A1
(43) Pub. Date: Oct. 21, 2021

(54) ALGORITHMIC ATTRIBUTION

(71) Applicant: Adobe Inc., San Jose, CA (US)

(72) Inventors: Ivan Ben Andrus, Saratoga Springs, UT (US); Trevor Hyrum Paulsen, Lehi, UT (US); Ritwik Sinha, Cupertino, CA (US)

(21) Appl. No.: 16/853,448

(22) Filed: Apr. 20, 2020

(51) Int. Cl. G06F 16/903; G06F 16/28; G06F 16/958

(52) U.S. Cl. CPC G06F 16/90335; G06F 16/958; G06F 16/287; G06F 16/283

(57) ABSTRACT

Introduced is a technique for assigning attribution values associated with a metric to dimensions in a set of data. An attribution model can be implemented to process data to assign attribution values to the dimensions in the data. The attribution model can be configured accordingly to game theoretic properties such as Shapley value. For example, each of the dimensions in the data may correspond to a different player in a cooperative game based on a specified value function. Using the specified value function, attribution values associated with a metric can be assigned to the dimensions in the data. The introduced technique can be implemented to assign attribution value associated with various types of metric to various types of dimensions. Further, the introduced technique is highly scalable and can be implemented to process data at query time without requiring any offline models to be run.

### TECHNICAL FIELD

The disclosed teachings generally relate to the field of data analytics. The disclosed teachings more particularly relate to an attribution technique.

### BACKGROUND

Attribution generally refers to the identification of actions, events, touchpoints, or other occurrences that contribute in some manner to an outcome and the assignment of value to such events associated with their relative contribution to the outcome. For example, in a marketing context, attribution can be applied to assign value to one or more marketing interventions or other events that contributed to a conversion event such as an order, a sale, a registration, etc.

### BRIEF DESCRIPTION OF THE DRAWINGS

FIG. 1 shows a block diagram of an example computing environment that includes an analytics platform;

FIG. 2 shows a block diagram of a high-level architecture of the analytics platform of FIG. 1;

FIG. 3 shows a flow diagram that illustrates an example process for attributing value associated with a metric to various dimensions included in a set of data;

FIG. 4A shows an architecture flow diagram that illustrates an example process for attributing value associated with a metric to various dimensions included in a set of data using the analytics platform of FIG. 1;

FIG. 4B shows an architecture flow diagram of an example process for obtaining data from a data source;

FIG. 5 shows a flow diagram of an example process for processing data using an attribution model to assign attribution values associated with a metric to various dimensions in the data;

FIG. 6 shows a flow diagram of an example process for processing data using an attribution model that is configured according to game theoretic properties of Shapley value;

FIG. 7 shows a flow diagram of an example process for considering non-converting paths when assigning attribution values to dimensions;

FIG. 8 shows a flow diagram of an example process for generating and displaying a first visualization using a first attribution model;

FIG. 9 shows a flow diagram of an example process for generating and displaying a second visualization using a second attribution model;

FIG. 10 shows an example process for enabling a user to select an attribution model;

FIG. 11 shows a first screen of an example graphical user interface (GUI) that includes an option to select from multiple different attribution models;

FIG. 12 shows a second screen of the example GUI that includes visualizations based on attribution values generated by an attribution model; and

FIG. 13 shows a block diagram of an example computer system in which at least some operations associated with an embodiment of the introduced technique can be performed.

### DETAILED DESCRIPTION

### Overview

Existing techniques for performing attribution include applying rule-based models to data to assign value. Rule-based models treat attribution as a process that is mainly dependent on the position of an event in a sequence of events. In other words, applying a rule-based model does not typically involve any parameter estimation. Some popular rule-based models include Last Touch, First Touch, Same Touch, Linear, U-Shaped, J-Shaped, Inverse J-Shaped, Time Decay, and Participation. A First Touch and Last Touch model would assign all credit for a given outcome to a first touch or a last touch respectively. As an illustrative example, a Last Touch model would assign all credit to a last action taken by a customer (e.g., viewing a webpage) before a conversion occurs (e.g., the customer submits an order) and would ignore all other actions that occurred prior to the last touch (e.g., a targeted email, a video viewed by the customer, an article read by the customer). While broadly used in the business analytics industry today, such models provide limited insight into the actual contribution of various events to an outcome, particularly where data associated with such events is becoming increasingly available.

Some existing approaches have been developed to perform multi-touch attribution in the marketing context. For example, platforms such as Google™, Bizable™ and Marketshare™ provide multi-touch attribution models that attempt to provide more significant insights into data, for example, by using analytical techniques such as log-log multi-regression models, Bayesian approaches, and diffusion models. While effective to an extent, such existing techniques are limited to the marketing intervention use case and fail to provide attribution solutions for other types of interactions. For example, such existing techniques are not able to attribute orders to particular types of videos viewed on a website.

Introduced therefore is a technique for performing attribution that addresses the above-mentioned challenges. Specifically, introduced herein is an algorithmic attribution model that adheres to game theoretic properties such as Shapley value. Shapley value generally refers to a solution in a cooperative game (also referred to as a “coalition game”) that provides “fair credit” to each player in a given coalition of players. Shapley value is fair in the sense that each player is assigned credit equal to the average contribution of that player across all coalitions of which that the player is a part. In an example embodiment, data is received, retrieved, or otherwise accessed from a database in response to a query of the database. This data is then processed, in real time or near real time (i.e., within seconds or fractions of a second), using an attribution model to assign attribution values associated with a metric to one or more dimensions in the data. The attribution model may be configured according to game theoretic properties such as Shapley value. For example, each of the one or more dimensions in the data may correspond to a different player in a cooperative game based on a specified value function.

The introduced technique represents a significant technological improvement in the field of data analytics for several reasons. First, the introduced technique is highly scalable to big data use cases involving a large number of interventions (players). For example, a given set of data may include information indicative of hundreds or thousands of individual events that occur prior to an outcome. These events may include, for example, individual webpages viewed by a user, individual videos viewed by a user, individual portions of a document viewed by a user, etc. Each event can be treated as one of hundreds or thousands of different players in a cooperative game according to the introduced technique. Second, the introduced technique is not limited to marketing interventions (e.g., email campaigns, targeted advertisements, etc.) and can instead attribute value associated with any metric to any dimension in a given set of data. For example, the introduced technique can operate natively within multiple constructs of a web analytics hierarchy (e.g., visitor, visit, hit, etc.) or can be applied to attribute value associated with any metric (base and/or calculated metrics) to any dimensions. Third, an attribution model associated with the introduced technique can be run at query-time without requiring the use of any offline models and with relatively little latency (e.g., results available within seconds instead of days). In some embodiments, the introduced attribution model can be implemented within a reporting architecture associated with a computing system for data analytics. In other words, an attribution model according to the introduced technique can be implemented without requiring data or scored observations to be transported between systems. Instead a model can be configured to work entirely off data returned in response to queries of a database.

The highly scalable nature of the introduced technique may be particularly suited to the field of digital marketing in which large amounts of data are collected and analyzed to try to identify aspects of digital marketing campaigns that contribute to desired results (e.g., conversion events such as orders, sales, subscriptions, etc.). Digital marketing campaigns can involve utilizing computer networks (e.g., the Internet) to promote, via various channels, products and services to individuals that access such networks using computing devices such as desktop computers and smart phones. Often such campaigns may involve providing access to various digital content items such as images, videos, web pages, targeted advertisements, direct emails, social media posts, etc. The computer technology used to implement such digital marketing channels provides a unique opportunity to obtain vast amounts of data on how end users view or interact with such digital content; however, the amount of data obtained also presents a challenge from a data analytics standpoint. For example, if a company's digital marketing campaign involves posting advertisements on thousands of different web pages that are viewed by millions of different end users, this activity may produce millions of data points each corresponding to a particular web page view. How them, can the company determine a value associated with of any of that activity towards some metric such as company revenue. Embodiments of the introduced technique can be applied to gain such insight. For example, an attribution model based on game theoretic properties such as Shapley value can be configured such that each of the web page views is a dimension that corresponds to different player in a cooperative game. Data, such as machine-generated log data associated with these web page views and other activity, can then be processed using the configured attribution model to assign value associated with any metric (e.g., revenue) to any one or more of the page views (i.e., dimensions). In this sense, the introduced technique may enable insight into the data that would not otherwise be practical or feasible using the human mind or other computer-implemented processes.

### Technology Environment

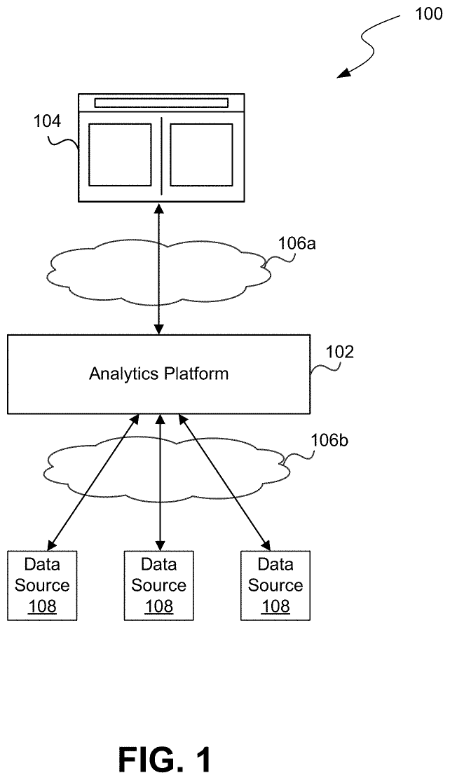

FIG. 1 shows a block diagram of an example computing environment 100 that includes an analytics platform 102 in which embodiments of the introduced technique can be implemented. A user (e.g., a data analyst) can interface with the analytics platform 102 via an interface 104 to access various functionalities provided by the analytics platform 102.

The analytics platform 102 may be connected to one or more networks 106a-b. The network(s) 106a-b can include local area networks (LANs), wide area networks (WANs), metropolitan area networks (MANs), cellular networks, the Internet, etc. The graphics platform 102 may also communicate with other computing devices over a short-range communication protocol, such as Bluetooth™ or Near Field Communication (NFC).

A user can access various functionalities provided by the analytics platform 102 via interface 104. In some embodiments, interface 104 may include a graphical user interface (GUI) through which visual outputs are displayed to a user and inputs are received from the user. The interface 104 may be accessible via one or more of a web browser, a desktop software program, a mobile application, an over-the-top (OTT) application, or any other type of application configured to present an interface to a user. Accordingly, the interface 104 may be accessed by the user on a user computing device such as a personal computer, mobile phone (e.g., Apple iPhone™), tablet computer (e.g., Apple iPad™) personal digital assistant (PDA), game console (e.g., Sony PlayStation™ or Microsoft Xbox™), music player (e.g., Apple iPod Touch™), wearable electronic device (e.g., Apple Watch™), network-connected (“smart”) device (e.g., a television or home assistant device), virtual/augmented reality system (e.g., a head-mounted display such as Oculus Rift® and Microsoft HoloLens®), or some other electronic device.

In some embodiments, the analytics platform 102 is hosted locally. That is, one or more of the computer programs associated with the analytics platform 102 may reside on the computing device used to access the interface 104. For example, the analytics platform 102 may be embodied as an application executing on a user's personal computer. In some embodiments, one or more components of the analytics platform 102 may be executed by a cloud computing service, for example, operated by Amazon Web Services™ (AWS), Google Cloud Platform™, Microsoft Azure™, or a similar technology. In such embodiments, some components of the analytics platform 102 may reside on one or more host computer servers that are communicatively coupled to one or more data sources 108 through which raw data may be received, retrieved, or otherwise accessed. The one or more data sources 108 can include, for example, websites, mobile devices, internet of things (IOT) devices, other devices, applications, third-party data sources, and any other sources from which data can be accessed. Data accessed from the one or more data sources can include, for example, voice data, video data, audio data, machine-generated data (e.g., network log data, web data, location data, sensor data, etc.), marketing data, or any other types of data.

In some embodiments, one portion of the analytics platform 102 may be hosted locally while another portion is hosted remotely (e.g., at a cloud computing service). For example, the analytics platform 102 may comprise a web or cloud-based analytics service (e.g., Adobe Analytics™) to which a user can subscribe to analyze their data. In such an embodiment, although executing locally at the user's computer, an analytics application (e.g., for reporting) may communicate with remote components of the analytics platform 102, for example to communicate software license information. The local and remote portions of the analytics platform 102 may communicate with each other via the one or more networks 106a-b. Certain embodiments are described in the context of network-accessible interfaces. However, those skilled in the art will recognize that the interfaces need not necessarily be accessible via a network. For example, a user computing device may be configured to execute a self-contained software program that does not require network access.

The analytics platform 102 may be configured to enable users' input data to be analyzed, specify data sources, store and process data, and generate and view reports to analyze their data. In some embodiments, the analytics platform 102 comprises a single application configured to perform various functionalities including processing data, performing attribution according to the introduced technique, and generating reports. In other embodiments, the analytics platform 102 may comprise multiple different applications each configured to perform different tasks. For example, a first application may be configured to perform attribution according to the introduced technique while a second application may be configured to perform attribution according to a different technique (e.g., rule-based attribution).

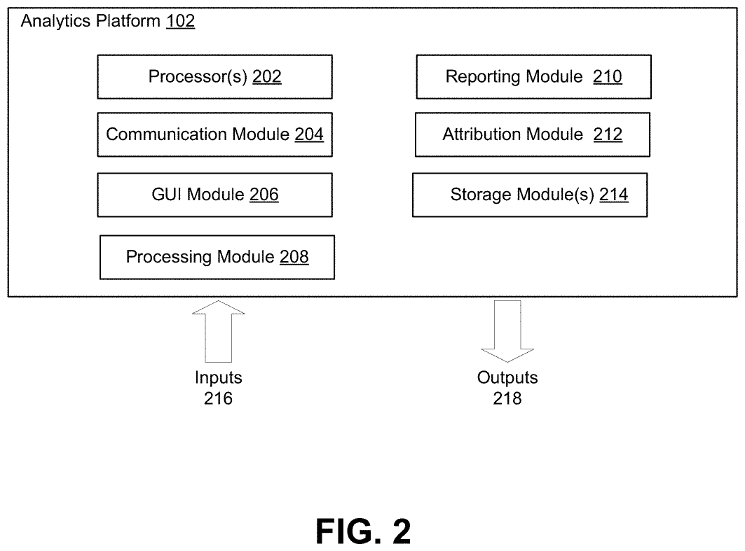

FIG. 2 shows a block diagram of a high-level architecture of an example analytics platform 102. The example analytics platform 102 can include one or more processors 202, a communication module 204, a GUI module 206, a processing module 208, a reporting module 210, an attribution module 212, and one or more storage modules 214. In some embodiments, a single storage module includes multiple computer programs for performing different operations (e.g., data extraction transformation and loading (ETL), performing attribution, generating reports, generating visualizations, etc.), while in other embodiments, each computer program is hosted within a separate storage module. Embodiments of the analytics platform 102 may include some or all of these components as well as other components not shown here.

The processor(s) 202 can execute modules (e.g., the processing module 208 and the graphics optimization module 212) from instructions stored in the storage module(s) 214, which can be any device or mechanism capable of storing information. The communication module 204 can manage communications between various components of the analytics platform 102. The communication module 204 can also manage communications between the computing device on which the analytics platform 102 resides and another computing device such as a user computing device (if separate).

For example, the analytics platform 102 may reside on a user computing device in the form of an application. In such embodiments, the communication module 304 can facilitate communication with a network-accessible computer server responsible for supporting the application (e.g., a software license server). The communication module 204 may facilitate communication with various data sources through the use of application programming interfaces (APIs), bulk data interfaces, etc.

As another example, the analytics platform 102 may reside on a server system that includes one or more network-accessible computer servers. In such embodiments, the communication module 204 can communicate with a software program executing on a user computing device to, for example, display a generated report. Those skilled in the art will recognize that the components of the analytics platform 102 can be distributed between the server system and the computing device associated with the individual in various manners. For example, some data may reside on the computing device of a user, while other data may reside on the server system.

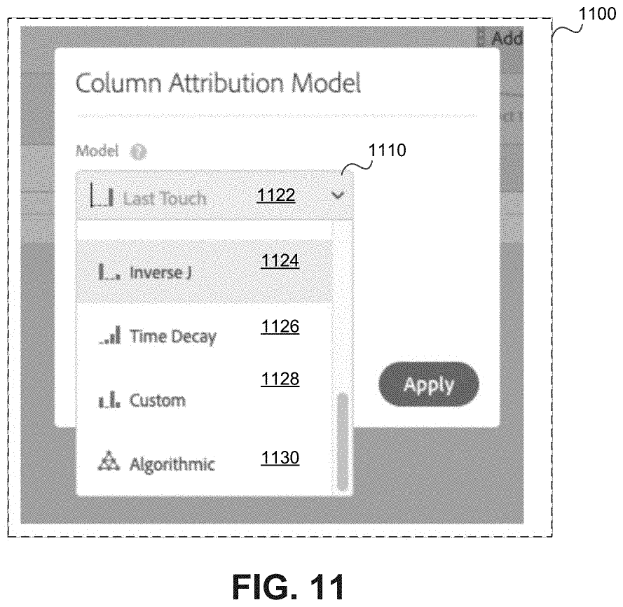

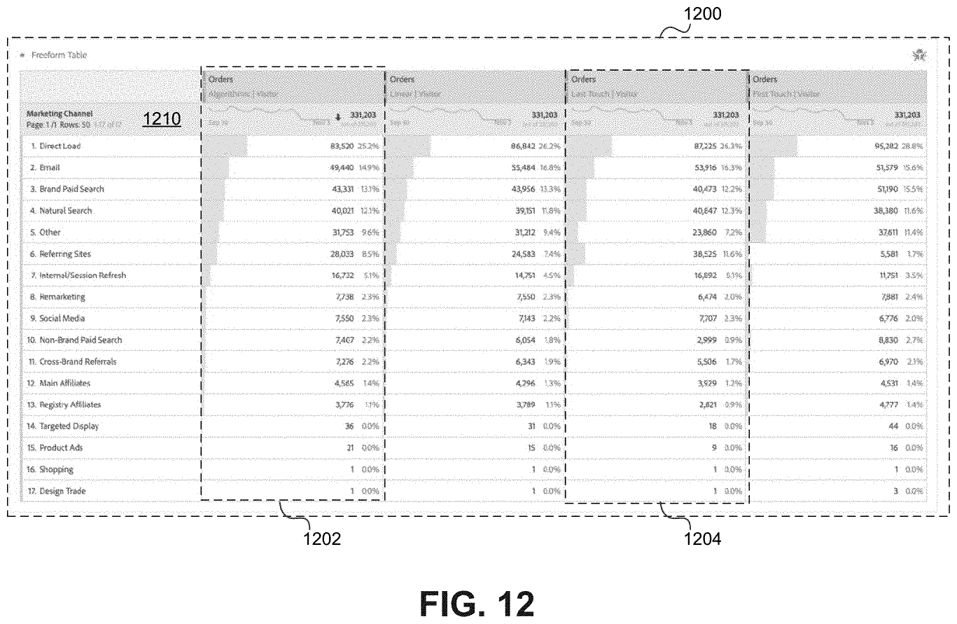

The GUI module 206 can generate GUIs through which the user can interact with the analytics platform 102 to, for example, input data to be analyzed, specify data sources, select an attribution model, and view attribution information and other reports. An example GUI associated with an analytics platform 102 is described with respect to FIGS. 11-12.

The processing module 208 can apply one or more operations to input data 216 acquired by the analytics platform 102 to provide certain functionalities described herein. Input data may include data obtained from the one or more data sources 108. Input data 216 may additionally include user input commands that are received, for example, via interface 204 to select an attribution model and perform attribution on the data from the data sources according to the introduced technique.

The reporting module 210 can process input data 216 to generate outputs 218. In some embodiments, the reporting module 210 is operable to query a database (e.g., a columnar database) for data. This data (i.e., input data 216) can be processed by the reporting module 210 to generate one or more reports (including visualizations). In some embodiments, the reporting module 210 can, in conjunction with the GUI module 206, present such reports to a user via a GUI (i.e., interface 104) at a user computing device.

The attribution module 212 can process data to apply an attribution process according to the introduced technique. In some embodiments, the attribution module 212 may include one or more attribution models including rule-based attribution models and algorithmic attribution models according to the introduced technique. In some embodiments, the attribution module 212 can, in conjunction with the reporting module 210 and/or GUI module 206, present an option in a GUI through which a user can select from the one or more available attribution models to apply to a given set of data. In some embodiments, the attribution module 212 may, in conjunction with the reporting module 210, receive data from a database in response to a query and process the data, in real time or near real time (i.e., within seconds or fractions of a second) using an attribution module to assign attribution values associated with a given metric to various dimensions indicated in the received data. Although depicted in FIG. 2 as a separate module, in some embodiments, the attribution module 212 may be part of the reporting module 210.

### Metrics and Dimensions

The introduced technique can be used to assign attribution values associated with any metric to various dimensions indicated in a dataset. Stated otherwise, the introduced technique can be applied to attribute portions of a total value of a metric to various dimensions in a dataset that contributed to the metric.

A “metric” generally refers to any quantitative calculation or measurement from and/or about a dataset. Consider for example, a dataset that includes data associated with people in the world. A useful metric associated with this dataset may include the average age of all the people represented in the dataset. Another metric associated with this data set may include the population in a given location. As another example, in a business context, a metric based on a set of customer data may include a number of orders, a number of registrations, a number of cart additions, an amount of revenue, an amount of profit, average number of orders per day, etc. As yet another example, in a network traffic context, a metric associated with a set of network traffic data may include a total number of sessions, a total number of page views per session, average time spent on a page, an amount of data transferred, etc. In short, a metric may be associated with any quantifiable result. In some embodiments, metrics may be broadly categorized into base metrics and calculated metrics. In this context, a “base metric” refers to stand alone metric that can be determined based on the dataset whereas a “calculated metric” results from combining metrics. For example, if number of Sessions and Page Views are two base metrics, then a calculated metric may include Page Views Per Session.

A “dimension,” in contrast, refers to an attribute associated with a dataset. Consider again the example of a dataset associated with people in the world. In such an example, the dataset may include a dimension associated with the country of origin or residence of each person. In such an example, evaluating an average age metric over a country dimension would result in a list of numbers indicating the average of people in each country.

In some cases, dimensions may include dimensional elements. For example, in the case of the country dimension, a dimensional element may include one of the multiple possible countries (e.g., Sweden). In other words, as used herein, a “dimensional element” may represent a particular element associated with a given dimension. Each dimension may include multiple different dimensional elements or may include one dimensional element. For illustrative simplicity, the term “dimension” shall be used herein to refer to both dimensions and dimensional elements. In other words, reference to a “dimension” may be construed to include reference to a “dimensional element.”

The introduced technique can be applied to various types of dimensions such as countable dimensions, simple dimensions, numeric dimensions, many-to-many dimensions, denormal dimensions, time dimensions, and derived dimensions.

Countable dimensions include dimensions in which a number of elements in the dimension can be counted by a computing system. Some examples of countable dimensions include Visitor, Session, Page, Booking, Order, etc.

Simple dimensions include dimensions that have a one-to-many relationship with a parent countable dimension. A simple dimension can be thought of as representing a property of elements of its parent dimension. An example simple dimension is Visitor Referrer with a parent of the Visitor dimension. Each Visitor can have only one Visitor Referrer (their first HTTP referrer), but many Visitors might have the same Visitor Referrer. Therefore, the Visitor Referrer is “one-to-many” with the Visitor dimension.

Numeric dimensions include dimensions that have numerical values and a one-to-many relationship with a parent countable dimension. A numeric dimension can be thought of as representing a numeric property of elements of its parent dimension. Numeric dimensions may be used to define “sum” metrics. An example numeric dimension is Session Revenue which defines the revenue, in dollars, for each Session. Each Session has a single amount of revenue, but any number of Sessions might have the same revenue, so Session Revenue is “one-to-many” with Session.

Many-to-many dimensions include dimensions that have a many-to-many relationship with a parent countable dimension. A many-to-many dimension can be thought of as representing a “set” of values for each element of its parent dimension. A many-to-many dimension may be equivalent to an (anonymous) countable dimension with its parent and a simple dimension with a parent of the anonymous countable dimension. An example of a many-to-many dimension is Search Phrase which has a parent of Session. Each Session can use zero or more Search Phrases, and a Search Phrase can be used in any number of Sessions.

Denormal dimensions include dimensions that have a one-to-one relationship with a parent countable dimension. In some cases, a denormal dimension can be thought of as storing an arbitrary string value for each element of the parent. An example denormal dimension is Email Address which has a parent of Visitor. Each Visitor has an Email Address, and each element of the Email Address dimension is associated with a single Visitor. Even if two visitors have the same e-mail address, their addresses will be different elements of the Email Address dimension.

Time dimensions include periodic and/or absolute time dimensions such as Day, Day of Week, Hour, Hour of Day, etc. Some time dimensions may also have relationships to a parent countable dimension. For example, a time dimension of Session Time may be a child to the Session dimension and may define a set of time dimensions (Day, Day of Week, Hour, Hour of Day, Month, and Week) whose elements correspond to the times at which visitors' sessions on the site began.

The above described metrics and dimension types are just examples provided for illustrative purposes and are not to be construed as limiting. As previously discussed, the introduced technique for attribution can be applied using any defined metric and/or dimensions.

Attributing Value Associated with a Metric to Various Dimensions

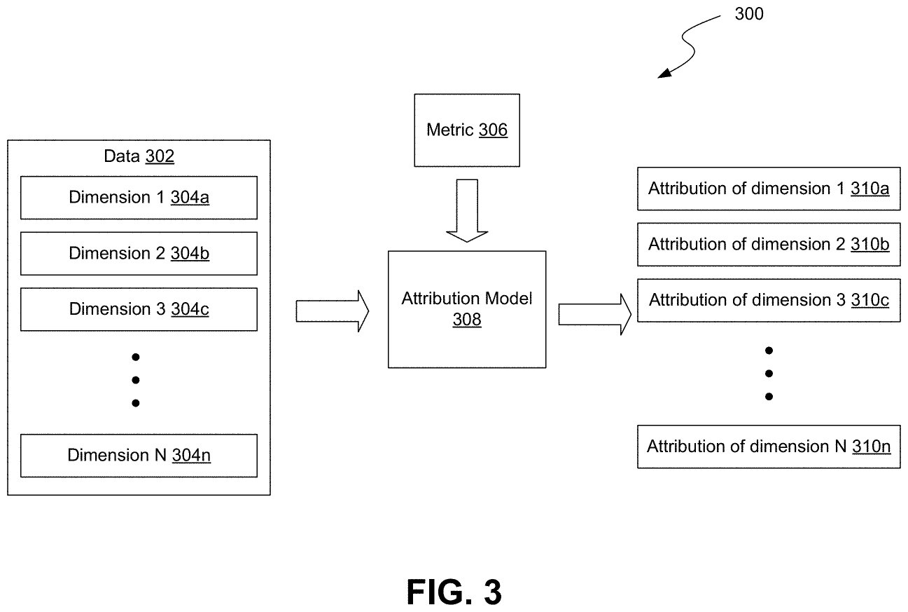

FIG. 3 shows a flow diagram 300 that illustrates an example process for attributing value associated with a metric to various dimensions included in a set of data. As shown in FIG. 3, a set of data 302 may include multiple dimensions 304a-304n. In some embodiments, one or more of the multiple dimensions 304a-n may actually represent dimensional elements. For example, dimension 1304a and dimension 2304b may represent two different dimensional elements (e.g., Sweden and China) of the same dimension (e.g., Country). The data 302 shown in FIG. 3 may represent a set of data retrieved from a database (e.g., a columnar database) in response to a submitted query. Alternatively, the data 302 may represent the entire database. The dimensions 304a-n may represent all of the dimensions in the given set of data 302 or may represent a subset of the dimensions that contribute in some way to a total value associated with a specified metric 306.

The data 302 is then processed using an attribution model 308 to assign values associated with a specified metric 306 to each of the multiple dimensions 304a-n of the data 302. The assigned values are depicted in FIG. 3 as attributions 310a-310n. The attribution model 308 shown in FIG. 3 may be one of multiple attribution models that can be applied by the analytics platform 102. For example, as previously discussed, the attribution module 212 may include multiple attribution models including rule-based models and models based on the introduced technique.

In an embodiment of the introduced technique, the attribution model 308 is configured to adhere to game theoretic properties such as Shapley value. Shapley value generally refers to a solution in a cooperative game that provides “fair credit” to each player in a given coalition of players.

In the context of assigning values to dimensions, each dimension may correspond to a different player in a cooperative game based on a specified value function that corresponds to a result such as a value of a metric. In an example embodiment, Shapley value involves the specification of a value function, (v(⋅)), that maps any set of players (e.g., corresponding to any set of dimensions) to the real line (e.g., a value of a specified metric). For example, let U represent the universe of players in a game. The value function v can then be represented as v:S⊆U→ [symbol] , where S is a coalition of players. If S is a coalition of players, then v(S) describes the total value that results from the sum of the values for each of the players in the coalition S. The value of the null set is 0. Using such a value function, the Shapley value of a player i can be represented by the following equation (1):

$${ϕ}_{i} ( v , U ) = {\sum }_{S ⊆ U ∖ \{ i \}} \frac{\vert S \vert ! ( \vert U \vert - \vert S \vert - 1 ) !}{\vert U \vert !} ( v ( S ⋃ \{ i \} ) - v ( S ) ) \qquad ( 1 )$$

Given this arrangement, Shapley value has the four following desirable properties:
1. Efficiency: The sum of Shapley value for all players is equal to the value of the grand coalition v(U).
2. Symmetry: Two players i and j are symmetric if v(S∪{i})=v(S∪{j}) for all S⊆U\{i,j}. Symmetric players get the same Shapley value, by design. In other words, if you have two players i and j that act the same, they are attributed the same value.
3. Null Player: Player i is a null player if v(S∪{i})=v(S) for all S. The null player will have a Shapley value of 0.
4. Additivity: ϕ satisfies additivity; for every pair of cooperative games (U,v) and (U,w), we have ϕ(v+w,U)=ϕ(v,U)+ϕ(w,U).

In some embodiments, Shapley value can be generalized using the Harsanyi dividend. The Harsanyi dividend identifies the surplus created by a coalition of players in a cooperative game. The dividend dᵥ (S) of coalition S in a game (v,U) can be recursively determined by the following:

dᵥ({i})=v({i})

dᵥ({i,j})=v({i,j})−dᵥ({i})−dᵥ({j})

dᵥ({i,j,k})=v({i,j,k})−dᵥ({i,j})−dᵥ({i,k})−dᵥ({i,k})−dᵥ({i})−dᵥ({j})−dᵥ({k})

and so on, until

$${d}_{v} ( S ) = v ( S ) - {\sum }_{T ⊆ S} {d}_{v} ( T ) .$$

Using these dividends, the Shapley value of player i can be determined by summing up the player's share of the dividends of all coalitions that the player i belongs to as shown in equation (2) below:

ϕᵢ(v)Σ_{S⊂U:i∈s}dᵥ(S)/|S|. (2)

As previously mentioned, Shapley value requires the specification of a value function. This value function can be specified in any manner that is consistent with the data being analyzed, with the only constraint on the value function being that the value of the null set (i.e., value of a set of no players) will be equal to 0.

A careful choice of the value function can enable implementation within an analytics platform (e.g., analytics platform 102) in a manner that is highly scalable and relatively easy to productionalize. Again, depending on the dataset being analyzed and the way in which dimensions are defined within the dataset, it is possible that the number of players in a cooperative game associated with attribution model 308 may be on the order of tens of players to hundreds of thousands of players. For example, a cooperative game associated with attribution of value to various marketing channels (e.g., targeted advertising, cold calls, email campaigns, etc.) may include tens of players each corresponding to a different marketing channel. Conversely, a cooperative game associated with attribution of value to various webpage views may include hundreds of thousands of players with each player corresponding to a different webpage view.

The following is a proposed dividend function and corresponding value function, according to an example embodiment of the introduced technique:
The dividend function (dᵥ(S)) is the total value of a metric for the set S, and excludes the value of the metric due to any strict subsets T⊂S. For example, in the case of visitors viewing web pages, if S={i, j}, then dᵥ (S) is the sum of the metric for all visitors who have viewed both web pages i and j, and nothing else.
The value function v(S) would be the total value of the metric for all visitors who have viewed any webpage i∈S, and nothing else.

The above choices for the dividend and value functions are examples provided for illustrative purposes and are not to be construed as limiting. That being said, in certain contexts, specifying the dividend and value functions as such can lead to various advantages. Consider, for example, a visitor that has seen a sequence of web pages i→i→j→k→R, where i, j, and k are dimensional elements and R is the value of the metric of interest (e.g., revenue). Then using equation (2), each of i, j, and k will be assigned an attribution value equal to R/3. In other words, by specifying the dividend function and value function as stated above, the Shapley value ends up being a “deduped linear,” in that a page viewed twice is not given more credit than other pages. This may be advantageous, from a computational standpoint, since the computation only requires looking at a single visit at a time instead of looking at multiple visits simultaneously as may be required if the value function is specified otherwise. Conversely, using this example, a linear attribution model would assign an attribution value of R/2, R/4, and R/4, to i, j, and k, respectively, and a participation model would assign an attribution value R to i, j, and k.

In some embodiments involving actions by multiple individuals, each individual can be represented as a different cooperative game for the purposes of attributing value to a metric. Consider again the example of attributing value associated with some metric (e.g., revenue) to various dimensions such as individual webpages. Each web page may be viewed by multiple visitors as indicated in the data that is processed using the attribution model. In this example, each visitor may correspond to a different one of multiple cooperative games. The value attributed to a particular player (e.g., corresponding to a particular webpage) would equal the sum of the Shapley value for the player across the multiple cooperative games associated with the multiple visitors.

Notably, the above described formulation for attributing value to various dimensions does not consider non-converting paths. For example, a visit to a web page may be assigned some attribution value associated with such a result (e.g., an order) using the above formulation; however, this value is not impacted if another visit to the page leads to a different result (e.g., no order).

In some embodiments, to produce more nuanced attribution values, an attribution model can be further configured to consider such non-converting paths. In an example embodiment, a similar determination regarding value as applied above can be used to attribute value to dimensions associated with non-converting paths. These can be combined to produce a final or adjusted attribution value for the dimensions.

For example, assume that Σᵢϕᵢ=R (the total of an outcome metric). Let ψᵢ be the attribution of visitors from the non-converting paths to the dimension i. This attribution value ψᵢ may be determined, for example, by specifying the outcome metric as Visitors. Normalizing both will then produce the following:

$${ϕ}_{i}^{′} = \frac{{ϕ}_{i}}{R}$$

$${ψ}_{i}^{′} = \frac{{ψ}_{i}}{\sum {ψ}_{i}}$$

Accordingly, if

$$\frac{{ϕ}_{i}^{′}}{{ψ}_{i}^{′}} > 1 ,$$

this implies that the dimension i shows up more often in the converting paths than the non-converting paths. This ratio can then be used to weight or otherwise adjust an attribution value associated with dimensional i and obtain a measure of the incremental effect of the exposures on the outcomes.

### Attribution in an Analytics Platform

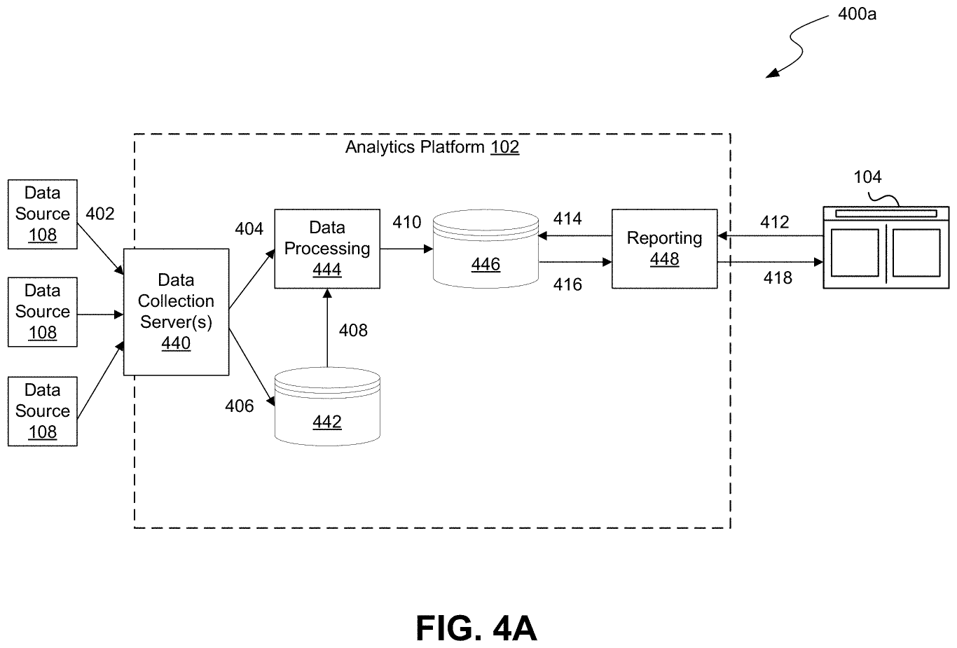

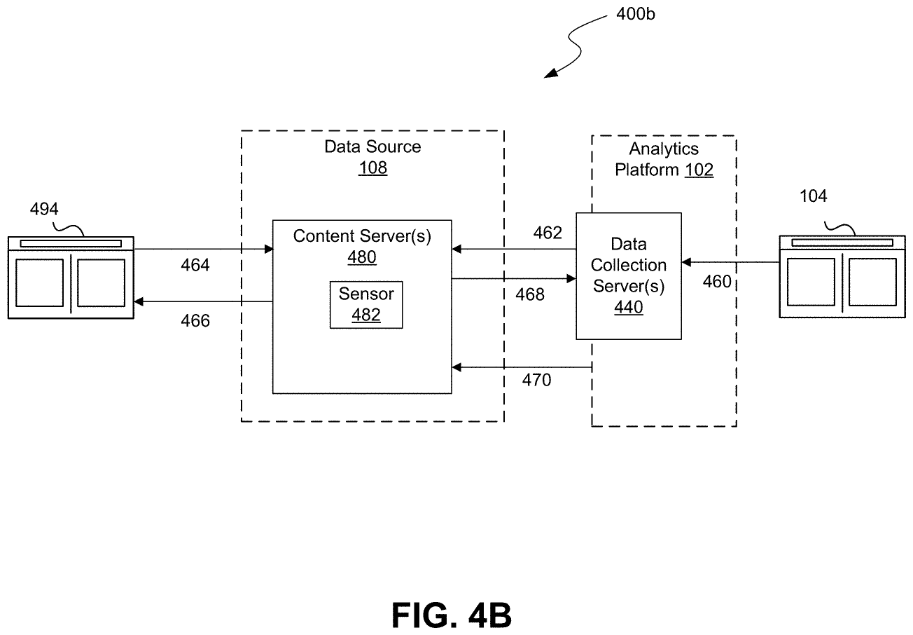

FIG. 4A shows an architecture flow diagram 400a that illustrates an example process for attributing value associated with a metric to various dimensions included in a set of data in the example context of an analytics platform 102.

At operation 402, raw data from various sources are received, retrieved, or otherwise acquired from one or more data sources 108. In some embodiments, the raw data from the data sources 108 are received, retrieved, or otherwise acquired by one or more data collection servers 440 associated with the analytics platform 102.

At operation 404, some or all of the raw data received, retrieved, or otherwise acquired by the data collection servers 440 may be preprocessed using data processing systems 444, for example, by applying extract, transform, load (ETL) operations.

Alternatively, or in addition, some or all of the raw data received, retrieved, or otherwise acquired by the data collection servers 440 may, at operation 406, be stored in a data warehouse 442 before undergoing preprocessing at operation 408.

In either case, at operation 410, the preprocessed data may be stored in a queryable database 446.

At operation 412, a user may provide an input via interface 104 that causes a reporting component 448 to, at operation 414, query the database 446. The reporting component 448 represents a reporting architecture within the analytics platform 102 configured to handle the generation and display of reports based on queries of the database 446. The reporting component 448 may correspond to the reporting module 210 described with respect to FIG. 2. In some embodiments, the reporting component 448 may additionally include the attribution module 212 described with respect to FIG. 2.

At operation 416, the reporting architecture may receive, retrieve, or otherwise access a dataset in response to the query at operation 414.

The dataset accessed at operation 416 can then be processed by the reporting component 448 to generate an output such as a report, including visualizations based on the data, which can then be presented, at operation 418, to the user via interface 104.

Notably, attribution according to the introduced technique can be performed at query time (also referred to as report time). In other words, an attribution model according to the introduced technique may be integrated into the reporting component 448. In some embodiments, query time processing is performed in real time or near real time (i.e., within seconds or fractions of a second) of receiving a dataset in response to a query. Further, such processing does not affect the underlying data stored in database 446 or in data warehouse 442. In some embodiments, the attribution values assigned to dimensions can be used to generate outputs such as visualizations which can be presented, at operation 418, to a user via interface 104. An example visualization based on attribution values generated by an attribution model is shown in FIG. 12.

In some embodiments, one or more of the data sources 108 may include a content server operating in a networked computing environment that hosts digital content items that are available for access by one or more end users. Such digital content may include images, videos, web pages, or any other digital content that are available for access to one or more end users. In some embodiments, such digital content may be associated with one or more digital marketing campaigns. FIG. 4B shows an architecture flow diagram 400a that illustrates an example process for obtaining data from such data sources.

At operation 460, a user of the analytics platform 102 provides an input (e.g., via interface 104) to set up a content server 480 to collect and transmit data to the analytics platform 102. The input provided at operation 460 may specify, for example, which content server to configure, what type of data to collect, when to collect the data, how to transform the data once collected, etc. For example, if the content server 480 is a web server, a user of the analytics platform may provide an input at operation 460 to collect and transmit web log data each time and end user accesses and views a particular web page hosted by the web server.

At operation 462, a computer system associated with the analytics platform may communicate instructions, over a computer network, to the content server 480 to configure the content server 480 (or an associated process) based on the input received at operation 460. In some embodiments, the data collection server 440 (described with respect to FIG. 4A) communicates such instructions to the content server 480. For example, the data collection server 440 may cause a sensor module 482 to be installed at the content server and/or may transmit instructions to configure or reconfigure a previously installed sensor module 482.

The sensor module 482 may include software instructions for monitoring requests made to the content server 480 to access content hosted by the content server 480. For example, an end user may view digital content hosted by the content server 480 using interface 494. Like interface 104 associated with the analytics platform 102, interface 194 may be accessible via one or more of a web browser, a desktop software program, a mobile application, an over-the-top (OTT) application, or any other type of application configured to present an interface to a user. Accordingly, the interface 194 may be accessed by the end user on a network-connected user computing device (e.g., a personal computer or smart phone). To view a digital content item hosted at the content server 480, the user computing device of the end user transmits, via a computer network, a request to the content server 480 at operation 464. In response, the content server 480 provides the requested content to the computing device of the end user at operation 466. This process may be performed each time an end user, for example, navigates to a web page hosted by the content server 480 or views a video hosted by the content server 480.

Each time an end user accesses or attempts to access content hosted by the content server 480, the content server 480 and/or the associated sensor 482 may generate machine data, for example, in the form of logs that are indicative of such interaction. Machine-generated log data may include information indicative of, for example, what digital content item was viewed or otherwise accessed, which specific portions of the digital content item were viewed or otherwise accessed (e.g., a portion of a video or a portion of a web page), how long the end user viewed or otherwise accessed the digital content item, a time at which the end user viewed or otherwise accessed the digital content item, a type of computing device used by the end user to view or otherwise access the digital content item, a physical location of the computing device used by the end user to view or otherwise access the digital content item, or any other associated information.

At operation 468, the content server 480 and/or the associated sensor 482 may transmit the machine-generated log data back to the data collection server 440 where the data is stored in a data warehouse 442 and/or processed and processed and stored in a queryable database 446 (e.g., as described with respect to FIG. 4A). In some embodiments, the content server 480 and/or the associated sensor 482 may label, annotate, add metadata, or otherwise modify the machine-generated log data before transmitting the data back to the data collection server 440.

In some embodiments, the analytics platform 102 may be configured to automatically control the content server 480 based on attribution values assigned to dimensional elements associated with the data. For example, a user may use analytics platform 102 to analyze how end users interact with digital content items (e.g., web pages) hosted at the content server 480. In such embodiments, each digital content item hosted at the content server 480 may be represented as a particular dimension or dimensional element in the data retrieved from the content server. Accordingly, the data can be processed at the analytics system 102 to assign attribution values associated with some metric (e.g., number of orders or sales) to each of the digital content items. Using this information, the analytics platform 102 can, at operation 470, communicate with the content server 480 to cause the content server 480 to adjust presentation of a digital content item. For example, if a particular attribution value associated with a digital content item indicates that the digital content item contributed towards the total value of a specified metric, the presentation of the digital content item can be adjusted to, for example, be more or less prominent.

In some embodiments, other digital content items can be selectively presented to end-uses based on attribution values assigned to other content items. Consider, for example, a web page hosted at a web server. Using an embodiment of the introduced technique, an attribution value associated with a metric (e.g., number of orders or sales) can be assigned to the web page. In response to assigning the attribution value, a computer system associated with the analytics platform may select, based on the attribution value, another digital content item such as a targeted advertisement (e.g., a video or an image) and cause the web server to modify the web page to include the selected digital content item.

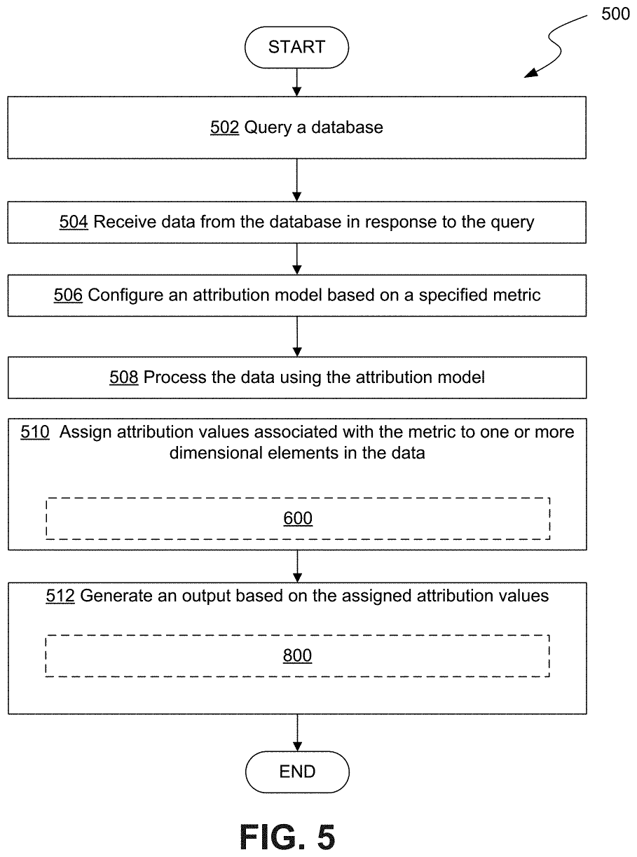

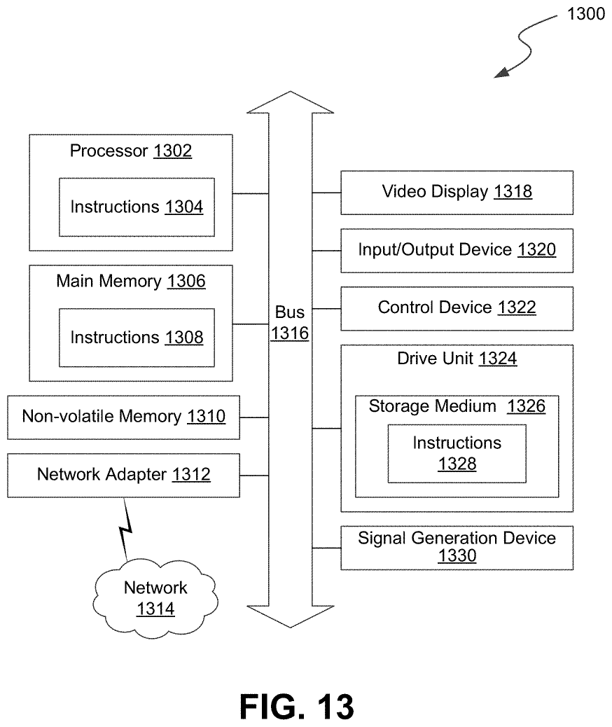

FIGS. 5-10 show various flow diagrams that describe example processes associated with the introduced technique for attributing value associated with a metric to various dimensions. One or more operations of the example processes of FIGS. 5-10 may be performed by any one or more computer systems associated with an analytics platform such as the analytics platform 102 described with respect to FIG. 1. In some embodiments, one or more operations of the example processes of FIGS. 5-10 may be performed by a computer system as described with respect to FIG. 13. For example, the processes described with respect to FIGS. 5-10 may be represented in instructions stored in memory that are then executed by a processing unit of a computer system. The processes described with respect to FIGS. 5-10 are examples provided for illustrative purposes and are not to be construed as limiting. Other processes may include more or fewer operations than depicted while remaining within the scope of the present disclosure. Further, the operations associated with the example processes may be performed in a different order than is shown in the flow diagrams of FIGS. 5-10. Certain operations associated with the flow diagrams of FIGS. 5-10 are described with respect to components depicted in FIGS. 1-4.

FIG. 5 shows a flow diagram of an example process 500 for processing data using an attribution model to assign attribution values associated with a metric to various dimensions in the data.

Example process 500 begins at operation 502 with querying a database. For example, with reference to FIG. 4A, a reporting component 448 of the analytics platform 102 may query the database 446 in response to an input indicative of a user request to query the database 446 received via interface 104. In some embodiments, the query includes one or more query criteria (e.g., a time range, type of dimension, data source, etc.). In some embodiments, the query criteria are based on an input, received via a GUI of the analytics platform 102, indicative of a request to query the database 446.

In some embodiments, the input received at operation 502 may also specify a metric to be applied to assign attribution values. For example, a user of the analytics platform that will analyze the data may specify a metric (e.g., total number of orders) to attribute value for various dimensions in the data. In other words, the input indicative of the user request to query the database 446 may be further be indicative of a user specified metric. The user specified metric may represent a selection of a particular metric from a plurality of predefined metrics or a custom metric. In this example, the “input” received at operation 502 may be based on single user interaction input or may be based on multiple user interaction inputs (e.g., various user inputs specifying query criteria, selecting a metric, confirming execution of the query, etc.). Example process 500 continues at operation 504 with receiving, retrieving, or otherwise accessing data from the database 446 in response to the query submitted at operation 502. The data received at operation 504 may represent a subset of all the data included in the database 446 that satisfy the query criteria associated with the query submitted at operation 502. As previously discussed, the data may include one or more dimensions.

Example process 500 continues at operation 506 with configuring an attribution model based on a specified metric. In some embodiments, the attribution model may be based on game theoretic properties such as Shapley value, for example, as described with respect to FIG. 3. That is, in some embodiments, the attribution model may be configured such that each of the multiple dimensions may correspond to a different one of a plurality of players in a cooperative game based on a specified value function. In some embodiments, the specified value function is based on the metric upon which attribution is being performed. As previously mentioned, in some embodiments, the metric is specified based on an input, received via interface 104, indicative of a user selection of a particular metric from multiple available metrics (base metrics and/or calculated metrics). In some embodiments, the metric is specified based on an input, received via interface 104, indicative of a user-defined custom metric. In other words, the specified value function may depend on an input, received via interface 104, indicative of a user selection of predefined metric and/or a user-defined custom metric.

Example process 500 continues at operation 508 with processing the data received at operation 504 using the attribution model (e.g., attribution model 308 of FIG. 3) configured at operation 506. In some embodiments, this includes inputting the data received at operation 504 into the configured attribution model to generate an out

Example process 500 continues at operation 510 with assigning, based on the processing performed at operation 508, attribution values associated with the metric to one or more of the dimensions in the data. In some embodiments, the assigned attribution values may represent the outputs of the attribution model used to process the data. In other embodiments, the assigned attribution values may represent results of further processing the outputs of the attribution model to, for example, weight or otherwise modify certain values, filter certain values, correct errors, etc.

In some embodiments, operations 508 and/or 510 are performed at query time (also referred to as report time). In other words, operations 508 and/or 510 are performed in real time or near real time (i.e., within seconds or fractions of a second) in response to receiving the data at operation 504. In other words, in such embodiments, the data is not processed using the attribution model until it is accessed in response to a query.

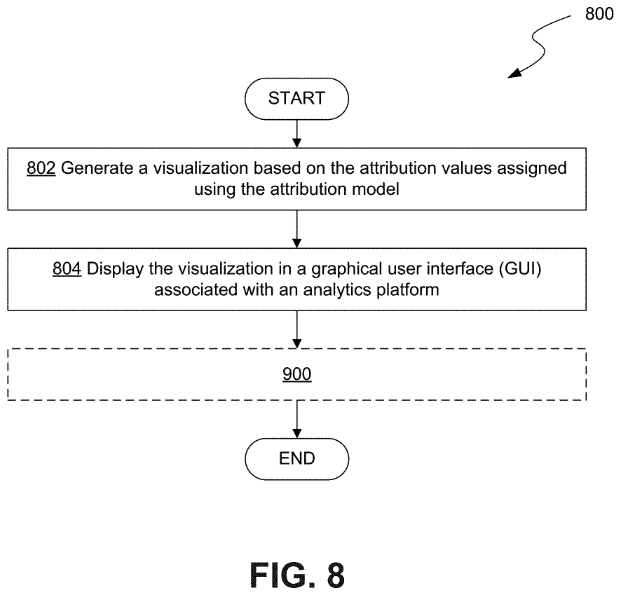

Example process 500 concludes at operation 512 with generating an output based on the attribution values assigned at operation 510. In some embodiments, the output generated at operation 512 includes attribution data indicative of the attribution values assigned at operation 510. In some embodiments, and as will be described with respect to FIG. 8, the output generated at operation 512 includes a visualization based on the attribution values assigned at operation 510. In any case, the output generated at operation 512 may, for example, be stored in a data storage associated with analytics platform 102, shared with another component or process associated with analytics platform 102, presented to a user of analytics platform 102, used to modify the data stored in queryable database 446 associated with analytics platform 102, used to configure a collection server 440 associated with analytics platform 102, used to configure one or more content servers 480, or any combination thereof.

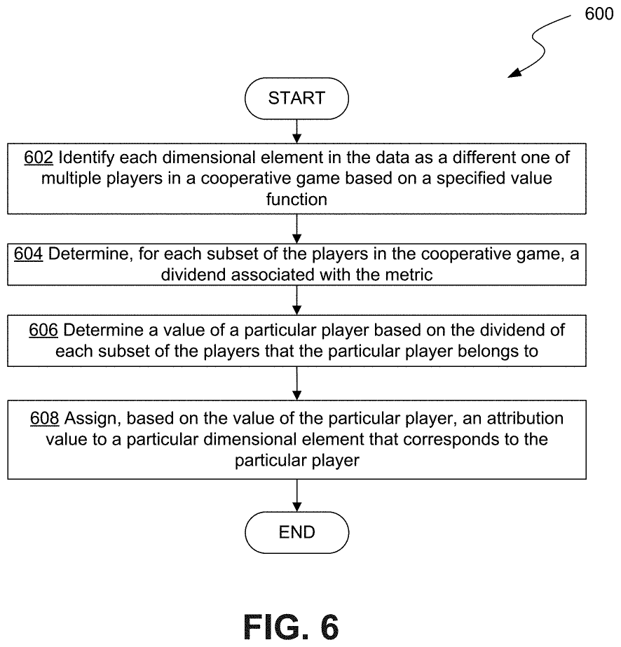

FIG. 6 shows a flow diagram of an example process 600 for processing data using an attribution model that is configured according to game theoretic properties of Shapley value. Example process 600 may represent a subprocess of operation 506 of example process 500, as indicated in FIG. 5.

Example process 600 begins at operation 602 with identifying one or more of the dimensions in the data (received at operation 504) as a different one of multiple players in a cooperative game based on a specified value function. In other words, each of the one or more dimensions may represent a player in a cooperative game, for example, as described with respect to FIG. 3. For example, a particular dimension (e.g., a particular page) may be identified as corresponding to a particular player i, in a cooperative game based on a specified value function that is used to determine a value (e.g., Shapley value) of the player.

Example process 600 continues at operation 604 with determining, for each subset (i.e., coalition) of players, a dividend (e.g., a Harsanyi dividend) associated with the metric, for example, as described with respect to FIG. 3. For example, the dividend may for a particular subset (i.e., coalition) may be recursively determined using a specified dividend function and the specified value function.

Example process 600 continues at operation 606 with determining a value of a particular player of the multiple players in the cooperative game based on the dividend (e.g., Harsanyi dividend) of each subset of the players that the particular player belongs to. For example, the value determined at operation 606 may be a Shapley value for the particular player that can be determined, for example, using equation (2).

Example process 600 continues at operation 608 with assigning, based on the value of a particular player determined at operation 606, an attribution value to a particular dimension that corresponds to the particular player. For example, as described at operation 602, each dimension corresponds to a different player in the cooperative game. Accordingly, the value of a particular player in the cooperative game corresponds to a value associated with a metric that is attributable to a particular dimension in the data that corresponds to the particular player.

In some embodiments, operations 606 and 608 are repeated for each of one or more players in the cooperative game to assign attribution values to each of the one or more dimensions in the data.

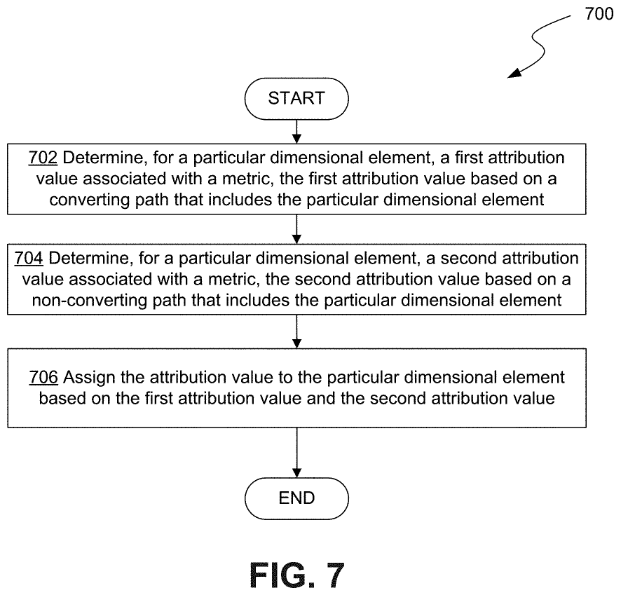

FIG. 7 shows a flow diagram of an example process 700 for considering non-converting paths when assigning attribution values to dimensions. Example process 700 may also represent a subprocess of operation 506 of example process 500.

Example process 700 beings at operation 702 with determining, for a particular dimension, a first attribution value based on a converting path that includes the particular dimension. For example, a first attribution value may be based on a result in a converting path such as an “order” using a technique similar to that described with respect to FIG. 6.

Example process 700 continues at operation 704 with determining, for the particular dimension, a second attribution value based on a non-converting path that includes the particular dimension. For example, a second attribution value may be based on a result in a non-converting path such as “no order” using a technique similar to that described with respect to FIG. 6.

Example process 700 concludes at operation 706 with assigning the attribution value to the particular dimension based on the first attribution value determined at operation 704 and the second attribution value determined at operation 706. In some embodiments, operation 706 may include determining a weighting factor based on the first attribution value and the second attribution value. For example, the weighting factor may be based on a ratio of the first attribution value to the second attribution value, for example, as described with respect to FIG. 3. The weighting factor can be applied to adjust an attribution value assigned to the particular dimension to produce a final assigned attribution value that is based on both converting paths and non-converting paths.

FIG. 8 shows a flow diagram of an example process 800 for generating and displaying a visualization based on the attribution values assigned to one or more dimensions in the data. Example process 800 may represent a subprocess of operation 508 of example process 500, as indicated in FIG. 5.

Example process 800 begins at operation 802 with generating a visualization based on the attribution values assigned to the one or more dimensions (e.g., at operation 506 in example process 500). In some embodiments, operation 802 may include processing attribution data indicative of the assigned attribution values using code associated with one or more visualization libraries to render the visualization. The visualization generated at operation 802 may include any type of visualization of data including a graph, a chart, a plot, a map, or any other type of visualization based on the attribution values. FIG. 12 shows some example visualizations of attribution data in the form of bar charts in which each dimensional element is associated with a visual bar that is sized based on its relative contribution to a total value of a specified metric. The visualizations depicted in FIG. 12 are just examples provided for illustrative purposes and are not to be construed as limiting. Other types of visualizations such as line graphs, pie charts, scatter plots, histograms, bubble charts, heat maps, etc. may similarly be generated based on the attribution data. In some embodiments, the type of visualization generated depends on the type of dimensions associated with the attribution data. For example, attribution values associated with a marketing channel dimension may be visualized using a bar chart whereas attribution values associated with physical locations are visualized using a heat map.

Example process 800 continues at operation 804 with displaying, or causing display of, the visualization in a GUI associated with an analytics platform such as analytics platform 102. For example, the visualization may be displayed in interface 104 at a user computing device that is accessible to a user of the analytics platform 102.

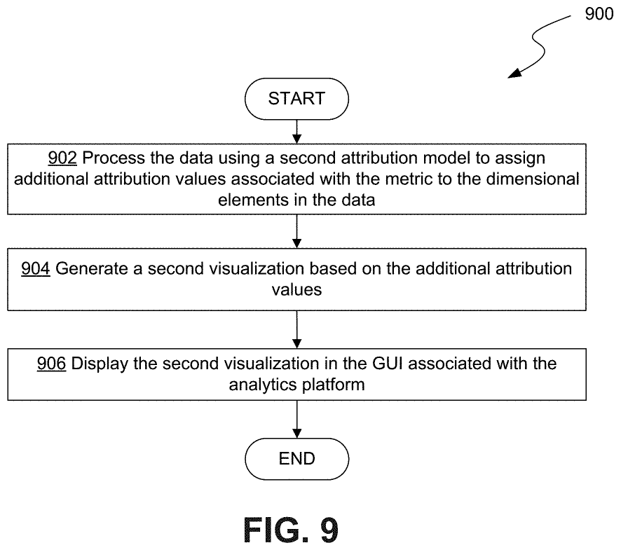

In some embodiments, visualizations of attribution data generated using different attribution models may be displayed in a GUI associated with an analytics platform 102. FIG. 9 shows a flow diagram of an example process 900 for generating and displaying a second visualization using a second attribution model. In some embodiments, example process 900 may be an optional part of example process 800, as indicated in FIG. 8.

Example process 900 begins at operation 902 processing the data (received at operation 504 of example process 500) using a second attribution model to assign additional attribution values associated with the metric to the one or more dimensions in the data. For example, the model used to process the data at operation 506 in example process 500 may be an attribution model according to the introduced technique, whereas the second attribution model used to process the data at operation 902 may be a different attribution model such as a rule-based attribution model or an attribution model associated with a different algorithm than the first attribution model. For example, in some embodiments, the second attribution model used at operation 902 is a rule-based attribution model such as Last Touch, First Touch, Same Touch, Linear, U-shaped, J-shaped, Inverse J-shaped, Time Decay, or Participation.

In some embodiments, operation 902 may be performed substantially in parallel with operation 506 of example process 500. That is, operations 506 and 902 may be performed substantially in parallel and in real time or near real time (i.e., within seconds or fractions of a second) in response to receiving the data at operation 504.

Example process 900 continues at operation 904 with generating a second visualization based on the additional attribution values assigned at operation 904, for example, similar to as described with respect to operation 802 of example process 800.

Example process 900 concludes at operation 906 with displaying the second visualization in the GUI associated with the analytics platform, for example, similar to as described with respect to operation 804 of example process 800. For example, FIG. 12 shows a screen of an example GUI that includes at least two different visualizations based on the processing of data using different attribution models.

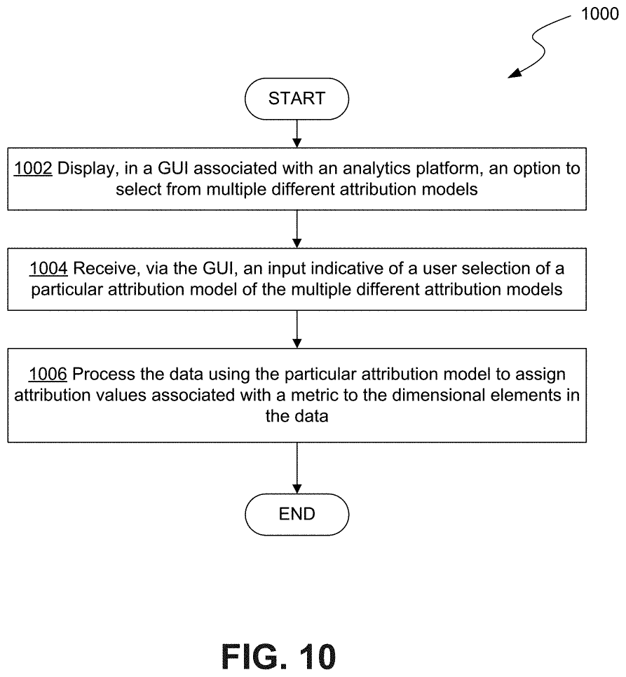

In some embodiments, the analytics platform 102 may enable a user to select from multiple different attribution models to generate and visualize attribution data. FIG. 10 shows an example process 1000 for enabling a user to select an attribution model.

Example process 1000 begins at operation 1002 with displaying, or causing display, of an option to select from multiple different attribution models. The option may be displayed in interface 104 (e.g., a GUI) at a user computing device that is accessible to a user of the analytics platform 102. The multiple different attribution models may include an attribution model according to the introduced technique as well as one or more other attribution models such as one or more rule-based attribution models. As previously mentioned, rule-based attribution models may include, for example, Last Touch, First Touch, Same Touch, Linear, U-shaped, J-shaped, Inverse J-shaped, Time Decay, or Participation. The option displayed at operation 1002 may include a graphical interface element such as a dropdown list, a radio button, a checkbox, etc. For example, FIG. 11 shows an illustrative example of an option in the form of a dropdown list.

Example process 1000 continues at operation 1004 with receiving, via the option displayed in GUI, an input indicative of a user selection of a particular attribution model of the multiple different attribution models.

Example process 1000 concludes at operation 1006 with processing the data (e.g., received at operation 504 of example process 500) using the particular attribution model to assign attribution values, for example, as described with respect to operation 506 in example process 500.

### Example Graphical User Interface

FIGS. 11 and 12 show screens of an example GUI associated with an analytics platform 102. For example, the screens depicted in FIGS. 11 and 12 may be part of an interface 104 of analytics platform 102 that is presented at a client device that is communicatively coupled to the analytics platform 102.

FIG. 11 shows a first screen 1100 of an example GUI that includes an option 1110 to select from multiple different attribution models. In the example shown in FIG. 11, the option 1110 is depicted as a dropdown menu from which a user can select from multiple different attribution models such as Last Touch 1122, Inverse J-shaped 1124, Time Decay 1126, Custom 1128, and Algorithmic 1130. In this example, models 1122-1128 may represent rule-based attribution models while model 1130 may represent a model based on the introduced technique. In an example embodiment, in response to receiving, via option 1110, an input indicative of a user selection of a particular model (e.g., model 1130), a computer system associated with analytics platform 102 may process data (e.g., data received in response to a query) using the particular model. The example option 1110 is depicted in FIG. 11 as a dropdown menu for illustrative purposes; however, this is not to be construed as limiting. Other types of graphical interface elements may similarly be implemented in other embodiments.

FIG. 12 shows a second screen 1200 of the example GUI that includes various visualizations based on attribution data. Specifically, screen 1200 shows various visualizations in the form of bar charts, such as visualization 1202 and visualization 1204. In the example depicted in FIG. 12, each visualization 1202 and 1204 is generated based on attribution values produced by different attribution models. For example, visualization 1202 may be based on attribution values for multiple dimensional elements that are assigned by processing input data using an algorithmic attribution model according to the introduced technique. Conversely, visualization 1204 may be based on additional attribution values for the multiple dimensional elements that are assigned by processing the same input data using a rule-based attribution model such as a Last Touch model.

In the example depicted in FIG. 12, each visualization includes multiple bars that are sized to correspond to an attribution value associated with a different one of multiple dimensional elements in the data. For example, column 1210 shows that the attribution values are associated with various dimensional elements associated with a Marketing Channel dimension such as Direct Load, Email, Natural Search, etc. For example, as shown in FIG. 12, visualization 1202 includes a bar in the row corresponding to the Direct Load dimensional element that is sized to correspond to an assigned attribution value of 83,520 (or 25.2%) out of a total value of the specified metric (in this case Orders) of 331,203. In other words, visualization 1202 conveys to a viewing user that 83,520 orders out of a total of 331,203 orders (or 25.2% of the total orders) can be attributed to a direct load marketing channel according to an attribution model associated with visualization 1202. The visualizations depicted in FIG. 12 are just examples provided for illustrative purposes and are not to be construed as limiting. Other embodiments may use different types of visualizations (e.g., line graphs, maps, etc.), may arrange the visualizations differently, or may depict more or fewer different visualizations than as shown.

### Example Computer System

FIG. 13 is a block diagram illustrating an example of a computer system 1300 in which at least some operations described herein can be implemented. For example, some components of the computer system 1300 may be part of a computer system associated with the analytics platform 102.

The computer system 1300 may include one or more processing units or (“processors”) 1302, main memory 1306, non-volatile memory 1310, network adapter 1312 (e.g., network interface), video display 1318, input/output devices 1320, control device 1322 (e.g., keyboard and pointing devices), drive unit 1324 including a storage medium 1326, and signal generation device 1330 that are communicatively connected to a bus 1316. The bus 1316 is illustrated as an abstraction that represents one or more physical buses and/or point-to-point connections that are connected by appropriate bridges, adapters, or controllers. The bus 1316, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 1300 may share a similar computer processor architecture as that of a server computer, a desktop computer, a tablet computer, a personal digital assistant (PDA), a mobile phone, a wearable electronic device (e.g., a watch or fitness tracker), a network-connected (“smart”) device (e.g., a television or home assistant device), virtual/augmented reality systems (e.g., a head-mounted display), or any other electronic device capable of executing a set of instructions (sequential or otherwise) that specify action(s) to be taken by the computer system 1300.

The one or more processors 1302 may include central processing units (CPUs), graphics processing units (GPUs), application specific integrated circuits (ASICs), programmable logic devices (PLDs), field programmable gate arrays (FPGAs), and/or any other hardware devices for processing data.

While the main memory 1306, non-volatile memory 1310, and storage medium 1326 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1328. The term “machine-readable medium” and “storage medium” shall also be taken to include any medium that is capable of storing, encoding, or carrying a set of instructions for execution by the computer system 1300.

In some cases, the routines executed to implement certain embodiments of the disclosure may be implemented as part of an operating system or a specific application, component, program, object, module, or sequence of instructions (collectively referred to as “computer programs”). The computer programs typically comprise one or more instructions (e.g., instructions 1304, 1308, 1328) set at various times in various memory and storage devices in a computing device. When read and executed by the one or more processors 1302, the instruction(s) cause the computer system 1300 to perform operations to execute elements involving the various aspects of the disclosure.

Operation of the main memory 1306, non-volatile memory 1310, and/or storage medium 1326, such as a change in state from a binary one (1) to a binary zero (0) (or vice versa) may comprise a visually perceptible physical change or transformation. The transformation may include a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1310, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1312 enables the computer system 1300 to mediate data in a network 1314 with an entity that is external to the computer system 1300 through any communication protocol supported by the computer system 1300 and the external entity. The network adapter 1312 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 1312 may include a firewall that governs and/or manages permission to access/proxy data in a computer network as well as tracks varying levels of trust between different machines and/or applications. The firewall can be any quantity of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method comprising:
receiving, by a computer system, an input specifying a database query and a metric;
causing, by the computer system, in response to receiving the input, execution of the database query;
receiving, by the computer system, in response to the database query, data from the database, the data including machine-generated data from a plurality of data sources in a networked computing environment, the data including a plurality of dimensional elements;
configuring, by the computer system, an attribution model according to game theoretic properties such that each of the plurality of dimensional elements correspond to a different one of a plurality of players in a cooperative game defined by a value function based on the metric;
processing, by the computer system, the data using the attribution model;
assigning, at query time, based on processing the data using the attribution model, attribution values associated with the metric to each of the plurality of dimensional elements in the data; and
causing display, by the computer system, of a visualization based on the attribution values for each of the plurality of dimensional elements.

2. The method of claim 1, wherein assigning the attribution values includes:
determining, for each subset of the plurality of players, a dividend associated with the metric using a dividend function based on the value function; and
determining a value of a particular player of the plurality of players based on the dividend of each subset of the plurality of players that the particular player belongs to;
wherein the particular player corresponds to a particular dimensional element of the plurality of dimensional elements; and
wherein the attribution value assigned to the particular dimensional element is based on the value of the particular player.

3. The method of claim 2,
wherein the dividend is a Harsanyi dividend; and
wherein the value of the player is a Shapley value.

4. The method of claim 1,
wherein the value function maps the plurality of players to a real value associated with the metric.

5. The method of claim 1, wherein an attribution value that is assigned to a particular dimensional element is based on a converting path that includes the particular dimensional element, the method further comprising:
determining a weighting factor based on a non-converting path that includes the particular dimensional element; and
adjusting the attribution value that is assigned to the particular dimensional element based on the weighting factor.

6. The method of claim 1, wherein the visualization includes any of a graph, a chart, a plot, or a map based on the attribution values.

7. The method of claim 1, further comprising:
presenting an option to select from a plurality of different attribution models to process the data; and
receiving a second input indicative of a user selection of a particular attribution model from the plurality of different attribution models;
wherein the attribution model used to process the data is the particular attribution model; and
wherein the data is processed, using the particular attribution model, in response to receiving the second input.

8. The method of claim 1, further comprising:
processing the data using a second attribution model; and
assigning, based on processing the data using the second attribution model, additional attribution values associated with the metric to each of the plurality of dimensional elements in the data, wherein the second attribution model is a rule-based attribution model.

9. The method of claim 8, further comprising:
causing display of a second visualization based on the additional attribution values for each of the plurality of dimensional elements that are assigned using the second attribution model.

10. The method of claim 1, wherein assigning the attribution values at query time includes assigning the attribution values in real time or near real time in response to receiving the data.

11. The method of claim 1,
wherein the plurality of data sources include a plurality of content servers operating in the networked computing environment;
wherein at least some of the data is extracted from the plurality of content servers by a data collection server for storage in the database, and
wherein one or more of the dimensional elements in the data correspond to digital content hosted by the plurality of content servers.

12. The method of claim 1, wherein a particular dimensional element of the plurality of dimensional elements in the data corresponds to a digital content item hosted by a content server operating in networked computing environment, the method further comprising:
causing the content server to adjust presentation of the digital content item based on a particular attribution value assigned to the particular dimensional element.

13. The method of claim 12, wherein the digital content item is any of an image, a video, or a web page.

14. The method of claim 1, further comprising:
selecting, based on one or more of the plurality of assigned attribution values, a content item from a plurality of available content items; and
causing a web server in the networked computing environment to modify a web page to include to include the content item.

15. A system comprising:
a processor; and
a memory coupled to the processor, the memory having instructions stored thereon which, when executed by the processor, cause the system to:
receive an input specifying a database query and a metric;
cause, in response to receiving the input, execution of the database query;
receive, in response to the database query, data from the database, the data including machine-generated data from a plurality of data sources in a networked computing environment, the data including a plurality of dimensional elements;
configure an attribution model according to game theoretic properties such that each of the plurality of dimensional elements correspond to a different one of a plurality of players in a cooperative game defined by a value function based on the metric;
process the data using an attribution model;
assign, at query time, based on processing the data using the attribution model, attribution values associated with a metric to each of the plurality of dimensional elements in the data; and
cause display of a visualization based on the attribution values for each of the plurality of dimensional elements.

16. The system of claim 15, wherein assigning the attribution values includes:
determining, for each subset of the plurality of players, a dividend associated with the metric using a dividend function based on the value function; and
determining a value of a particular player of the plurality of players based on the dividend of each subset of the plurality of players that the particular player belongs to;
wherein the particular player corresponds to a particular dimensional element of the plurality of dimensional elements; and
wherein the attribution value assigned to the particular dimensional element is based on the value of the particular player.

17. The system of claim 15, wherein an attribution value that is assigned to a particular dimensional element is based on a converting path that includes the particular dimensional element, and wherein the memory has further instructions stored thereon which, when executed by the processor, cause the system to further:
determine a weighting factor based on a non-converting path that includes the particular dimensional element; and
adjust the attribution value that is assigned to the particular dimensional element based on the weighting factor.

18. A non-transitory computer-readable medium storing instructions, execution of which in a computer system, causes the computer system to:
receive an input specifying a database query and a metric;
cause, in response to receiving the input, execution of the database query;
receive, in response to database query, data from the database, the data including machine-generated data from a plurality of data sources in a networked computing environment, the data including a plurality of dimensional elements;
configure an attribution model according to game theoretic properties such that each of the plurality of dimensional elements correspond to a different one of a plurality of players in a cooperative game defined by a value function based on the metric;
process the data using the attribution model;
assign, at query time, based on based on processing the data using the attribution model, attribution values associated with the metric to each of the plurality of dimensional elements in the data; and
cause display of a visualization based on the attribution values for each of the plurality of dimensional elements.

19. The non-transitory computer readable medium of claim 18, wherein assigning the attribution values includes:
determining, for each subset of the plurality of players, a dividend associated with the metric using a dividend function based on the value function; and
determining a value of a particular player of the plurality of players based on the dividend of each subset of the plurality of players that the particular player belongs to;
wherein the particular player corresponds to a particular dimensional element of the plurality of dimensional elements; and
wherein the attribution value assigned to the particular dimensional element is based on the value of the particular player.

20. The non-transitory computer-readable medium of claim 20, storing further instructions, execution of which in the computer system, causes the computer system to further:
determine a weighting factor based on a non-converting path that includes the particular dimensional element; and
adjust the attribution value that is assigned to the particular dimensional element based on the weighting factor.
